(19) United States
(12) Patent Application Publication
(10) Pub. No.: US 2021/0357098 A1
(43) Pub. Date: Nov. 18, 2021

(54) INFORMATION PRESENTATION SYSTEM AND NON-TRANSITORY COMPUTER READABLE MEDIUM

(71) Applicant: FUJIFILM Business Innovation Corp., Tokyo (JP)

(72) Inventor: Hirotake SASAKI, Kanagawa (JP)

(73) Assignee: FUJIFILM Business Innovation Corp., Tokyo (JP)

(21) Appl. No.: 17/128,169

(22) Filed: Dec. 20, 2020

(30) Foreign Application Priority Data
May 15, 2020 (JP) 2020-086216

(51) Int. Cl. G06F 3/0481; G06F 3/0484; G06F 3/0483; G06F 3/01

(52) U.S. Cl. CPC G06F 3/04815; G06F 3/011; G06F 3/0483; G06F 3/04842

(57) ABSTRACT

An information presentation system includes a display that provides a virtual three-dimensional (3D) work space to a user, an inputter that the user uses to operate an object in the virtual 3D work space, and a processor configured to cause the display to display the 3D work space, cause the display to display a document in the 3D work pace, cause the display to display in the 3D work space a representative object, representing the document, in association with the document and, in response to detection of an operation performed by the inputter on the representative object in the 3D work space, perform a process to process multiple pages forming the document represented by the representative object.

### CROSS-REFERENCE TO RELATED APPLICATIONS

This application is based on and claims priority under 35 USC 119 from Japanese Patent Application No. 2020-086216 filed May 15, 2020.

### BACKGROUND

### (i) Technical Field

The present disclosure relates to an information presentation system and a non-transitory computer readable medium.

### (ii) Related Art

Physical work space typically includes a location where a desk or like is placed and once the work space is determined, the size thereof is not easy to change. Since data synchronization between analog media and digital media is difficult to achieve, conversion therebetween is frequently performed. In contrast, a virtual work space is free such restrictions and is capable of providing an environment where thinking is uninterruptedly performed by increasing the degree of freedom in display and operations.

Japanese Unexamined Patent Application Publication No. 2000-194475 discloses a technique that allows a user not familiar with machine operation to easily manage and view a document. In a creation information input operation, information used to create a graphic model of a three-dimensional (3D) book is input. The information includes the number M of pages of the book, page size A4, and file index to an page image attached to each page. The file index includes a higher resolution and a lower resolution. In a 3D model creation operation, the graphic model of the 3D book is created based on creation information obtained in the creation information input operation. In a texture mapping operation, a page image on a memory is attached onto each page model through texture mapping in accordance with storage information of an image corresponding to each page of the 3D model of the book obtained in the creation information input operation. Images of higher resolution and lower resolution are prepared for the same page as the page images to be stored.

Japanese Unexamined Patent Application Publication No. 2004-246712 discloses a technique that increases browsability of an object by three-dimensionally display a hierarchical structure of the object deep in hierarchy and enables a relationship and a growth process of an object group to be analyzed or browsed. Multiple images serving as a thumbnail of a document and video forming an object are displayed in a polyhedral shape on a display. If there are numerous images, one image may be stacked beneath (or on top of) another. A user may check contents and a configuration of the object from the image that is a thumbnail displayed in 3D graphic user interface (GUI). The user may operate a cursor in a display region using an inputter. When the cursor is placed on the image, the title name of the image is displayed in characters.

Japanese Unexamined Patent Application Publication No. 2013-175161 discloses a technique of a panoramic visualization document navigation system that panoramically visualizes a document or document components thereof through a method that accounts for a logical relationship between the document and document components. The panoramic visualization document navigation system includes a navigation engine and a request interface. The navigation engine is configured to receive the layout of document components in a panoramic visualization document collection of the document components. Each of the document components includes related meta data that provides information related to each document component. The navigation engine is configured to adjust the visual expression of the layout in accordance with a request.

When a large number of documents are read, comparison and reference are often made by arranging pages side by side or overlapping one document on another. In such a job, work space accommodating documents, such as a desk, may be used. The use of a virtual three-dimensional (3D) space helps provide work space and increases the freedom of operation, leading to an improvement in document browsability.

If multiple pages forming a document are widely spread thanks to the high degree of freedom, grouping the pages again in accordance with a given rule may be time-consuming, leading to a drop in work efficiency.

### SUMMARY

Aspects of non-limiting embodiments of the present disclosure relate to providing a technique that operates pages of a document by grouping the pages in a virtual 3D work space created by a computer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information presentation system including a display that provides a virtual three-dimensional (3D) work space to a user, an inputter that the user uses to operate an object in the virtual 3D work space, and a processor configured to cause the display to display the 3D work space, cause the display to display a document in the 3D work pace, cause the display to display in the 3D work space a representative object representing the document in association with the document and, in response to detection of an operation performed by the inputter on the representative object in the 3D work space, perform a process to process a plurality of pages forming the document represented by the representative object.

### BRIEF DESCRIPTION OF THE DRAWINGS

Exemplary embodiments of the present disclosure will be described in detail based on the following figures, wherein:

FIG. 1 is a configuration diagram of an exemplary embodiment;

FIG. 2 illustrates a head-mounted display of the exemplary embodiment;

FIG. 3 illustrates an example of a xR space of the exemplary embodiment;

FIG. 4 illustrates a file system of the exemplary embodiment;

FIG. 5 illustrates an object in the xR space of the exemplary embodiment;

FIG. 6 illustrates an operation performed on a representative object of the exemplary embodiment;

FIG. 7 illustrates a coordinate system of a representative object and an object belonging to the representative object in accordance with the exemplary embodiment;

FIG. 8 illustrates a table listing a data structure of the representative object and objects belonging to the representative object in accordance with the exemplary embodiment;

FIG. 9 is a process flowchart of the exemplary embodiment;

FIG. 10 is another process flowchart of the exemplary embodiment;

FIG. 11A is a diagram illustrating a movement operation performed on the representative object of the exemplary embodiment;

FIG. 11B is another diagram illustrating the movement operation performed on the representative object of the exemplary embodiment;

FIG. 12A is a diagram illustrating the movement operation performed on only the representative object of the exemplary embodiment;

FIG. 12B is another diagram illustrating the movement operation performed on only the representative object of the exemplary embodiment;

FIG. 13A is a diagram illustrating a display/undisplay operation performed on the representative object of the exemplary embodiment;

FIG. 13B is another diagram illustrating the display/undisplay operation performed on the representative object of the exemplary embodiment;

FIG. 14A is a diagram illustrating an alignment operation of the representative object of the exemplary embodiment;

FIG. 14B is another diagram illustrating the alignment operation performed on the representative object of the exemplary embodiment;

FIG. 15A is a diagram illustrating a differentiating operation performed on the representative object of the exemplary embodiment;

FIG. 15B is another diagram illustrating the differentiating operation of the representative object performed on the exemplary embodiment;

FIG. 16A is a diagram illustrating a partial selection operation performed on the representative object of the exemplary embodiment;

FIG. 16B is another diagram illustrating the partial selection operation performed on the representative object of the exemplary embodiment;

FIG. 17A is a diagram illustrating a modification operation performed on the representative object of the exemplary embodiment; and

FIG. 17B is another diagram illustrating the modification operation performed on the representative object of the exemplary embodiment.

### DETAILED DESCRIPTION

Exemplary embodiments of the present disclosure are described with reference to the drawings.

### Configuration

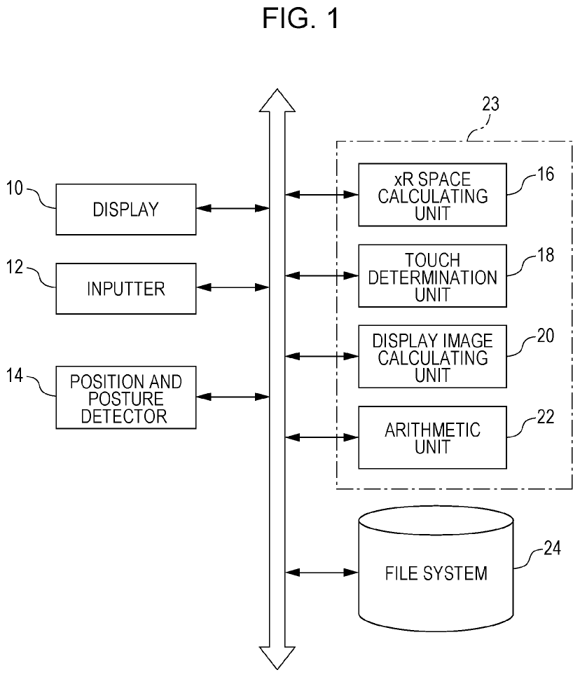

FIG. 1 illustrates a configuration of an information presentation system of the exemplary embodiment. The information presentation system includes a display 10, inputter 12, position and posture detector 14, xR space calculating unit 16, touch determination unit 18, display image calculating unit 20, arithmetic unit 22, and file system 24.

The display 10 presents a virtual three-dimensional space to a user to allow the user to view or operate a document. The display 10 provides parallax to the user such that the user may recognize a three-dimensionally space, such as depth. For example, the display 10 capable of providing parallax includes but is not limited to a binocular head-mounted display. The position and posture of the display 10 in an actual space are detected by the position and posture detector 14 and reflected in a display object in the virtual three-dimensional (3D) space.

The inputter 12 is used by a user to operate an object displayed in the virtual 3D space. The position and posture of the inputter 12 in the real space are detected by the position and posture detector 14 and reflected in an input object in the virtual 3D space. The inputter 12 may be a physically present device, such as a controller for the virtual 3D space or may be the hand of the user detected by a sensor. One or more inputters 12 may be employed. Detection signals of the position and posture of the inputter 12 are transmitted from the position and posture detector 14 to the arithmetic unit 22 as operation signals to the object. The transmission timing of the operation signals may be triggered by an operation on a physical button on the inputter 12 or by a recognition result of the gesture of the user hand detected by the sensor.

The position and posture detector 14 detects the position and posture of the inputter 12 and the display 10 in the real space. The position and posture detector 14 may be internal or external to the display 10.

The xR space calculating unit 16 reflects in the virtual 3D space the position and posture of the inputter 12 and the display 10 detected by the position and posture detector 14 and calculates the positions and postures of all objects in the virtual 3D space. All objects in the virtual 3D space include the display as an object (display object), the inputter as an object (inputter object), representative object of a document as a representative object, and object(s) belonging to the representative object. The position and posture of the display object in the virtual 3D space are calculated in accordance with information on the real space detected by the position and posture detector 14. The position and posture of the inputter object in the virtual 3D space are calculated in accordance with information on the real space detected by the position and posture detector 14. xR herein is a generic term representing a technique implementing the virtual 3D space. Specifically, xR includes virtual reality (VR), augmented VR (AR), and mixed reality (MR). The virtual 3D space is collectively referred to as xR space.

The touch determination unit 18 determines whether objects touch each other in the xR space.

Based on the position and posture of the display unit object in the xR space, the display image calculating unit 20 calculates an image that is to be displayed. The display image calculating unit 20 outputs the calculated image to the display 10.

The arithmetic unit 22 performs a variety of calculations. The arithmetic unit 22 may be internal to the display 10.

The file system 24 manages the inputting and outputting of a document that the user views or operate in the xR space. The document is managed by the file system 24 as digital data. The file system 24 may be a server computer separate from the arithmetic unit 22 or connected to the arithmetic unit 22 via a communication network. The document typically includes one or more pages and each page has its attribute. When the document is output in the xR space, a representative object is created. The pages forming the document are respectively converted into separate objects that belong to the representative object.

The representative object and the objects have position and posture information in the xR space. The objects belonging to the representative object have relative position and posture information relative to the coordinate system of the representative object. The relative position and posture information may be stored in advance or may be calculated each time when the information presentation system is used. These pieces of position and posture information are stored in the file system 24.

The xR space calculating unit 16, touch determination unit 18, display image calculating unit 20, and arithmetic unit 22 may be implemented by a processor 23 in a computer. By reading and executing a process program stored on a program memory, such as a read-only memory (ROM), the processor 23 functions as the xR space calculating unit 16, touch determination unit 18, display image calculating unit 20, and arithmetic unit 22. The processor 23 refers to a processor in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). Jobs of the processor 23 may be performed not only by a single processor but also by plural processors in collaboration which are located physically apart from each other but may work cooperatively. The jobs of the processor 23 are listed below.

(1) The processor 23 calculates the xR space and causes the display 10 to display the xR space.

(2) The processor 23 places multiple objects of an document in the xR space and causes the display 10 to display the objects in the xR space.

(3) The processor 23 creates a representative object representing the multiple objects of the document and causes the display 10 to display the representative object in the xR space.

(4) The processor 23 detects an operation on an object in the xR space in response to an operation on the inputter 12 performed by the user and operates the object in response to the contents of the operation on the object.

(5) The processor 23 detects an operation on the representative object in the xR space in response to an operation on the inputter 12 performed by the user and collectively operates the objects belonging to the representative object in response to the contents of the operation on the object.

As previously described, the display 10, inputter 12, and position and posture detector 14 may be implemented, for example, by the head-mounted display and xR controller. The head-mounted display is to be worn on the head of a person. The head-mounted display may use a virtual image projection method that forms a virtual image by using a half mirror and presents the image to the user. Alternatively, the head-mounted display may use a retinal projection method that directly forms an image on the retina by using the lens of the eye. The head-mounted display may be a three-degree of freedom method that detects inclinations of XYZ axes. The head-mounted display may be a six-degree of freedom method that detects positional information in a 3D space in addition to the inclinations. The head-mounted display may convert a motion of a user to the xR space by tracking infrared light emitting diodes (IRLEDs). The xR controller operates in cooperation with the head-mounted display. By operating the xR controller, the user moves a virtual hand serving as an object displayed in the xR controller as if the virtual hand were his or her own hand. The xR controller may not necessarily be used and a sensor in the head-mounted display may detect the hand of the user.

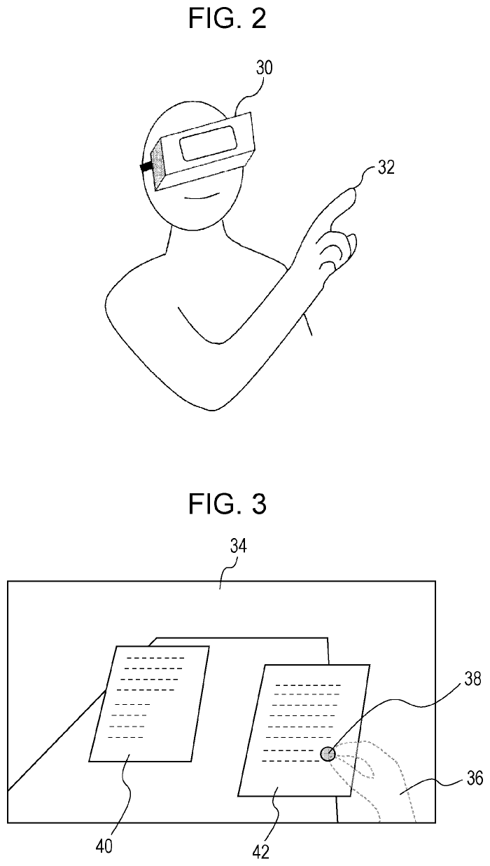

Referring to FIG. 2, a head-mounted display 30 is used. The user wears the head-mounted display 30 on his or her head and views the xR space displayed on the display 10. The head-mounted display 30 includes the display 10 and the position and posture detector 14. The head-mounted display 30 also detects the motion of a hand 32 of the user serving as the inputter 12.

FIG. 3 illustrates an example of an xR space 34 viewed by the user who wears the head-mounted display 30. The xR space 34 is a 3D space having a depth and specific positions and specific postures of a variety of objects are displayed in the xR space. FIG. 3 illustrates objects 40 and 42. An object 36 serving as a virtual hand is displayed in the xR space 34 and an object 38 serving as a marker is displayed at the tip of the virtual hand. When the user moves the hand 32 in the real space, the object 36 as the virtual hand in the xR space moves in the xR space in conjunction with the real hand. The user may thus move the object 36 in the xR space 34 as if the object 36 were his or her own hand. When the user turns around in the real space, the xR space 34 also moves in concert with the user. The type, position, and posture of a displayed object also change.

The objects 40 and 42 are displayed in the actual size. The user may hold the objects 40 and 42 by operating the object 36 as the virtual hand and may move the objects 40 and 42 held within the xR space by moving the hand 32 in the real space. The user may place the objects 40 and 42 at any position in the xR space 34 by moving the objects 40 and 42. Unlike in the real space, the user may place the objects 40 and 42 at any position in the xR space 34 without being aware a physical support.

The degree of freedom of operation of the objects 40 and 42 in the xR space 34 is higher. If multiple pages forming an object are spread in a wide area in the xR space 34, grouping the pages again in accordance with a given rule may be time-consuming, leading to a drop in work efficiency. For example, referring to FIG. 3, not only the objects 40 and 42 but also multiple other objects may be placed. If some objects are moved to a given location in the xR space 34, moving the objects with each of the objects grabbed by the object 36 as the virtual hand is more time consuming than collectively moving the objects together at a time.

According to the exemplary embodiment, the representative object representing the objects is used.

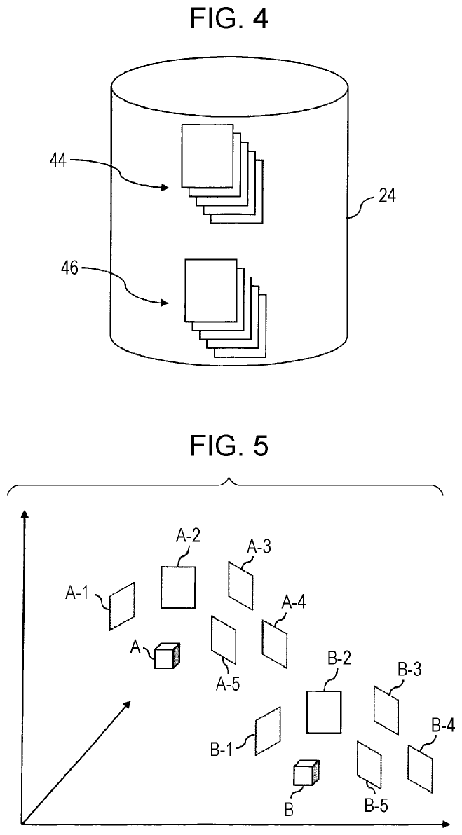

FIG. 4 illustrates documents 44 and 46 stored in the file system 24. The document 44 is a document A including multiple pages. The document 46 is a document B different from the document A and includes multiple pages. The document typically includes multiple pages with each page having its attribute but a single page document is also acceptable. When the document is output into the xR space 34, the representative object is created. The pages forming the document are converted to independent objects belonging to the representative object.

The representative object and the objects thereof have position and posture information in the xR space 34. The objects belonging to the representative object has relative position and posture information with respect to the coordinate system of the representative object. Specifically, the object belonging to the representative object may be interpreted as an object subordinate to the representative object.

FIG. 5 illustrates the documents 44 and 46 displayed in the xR space 34. The document 44 is displayed as pages A-1 through A-5 serving as objects in the xR space defined by three axes X, Y, and Z. The pages are hereinafter referred to as objects A-1 through A-5. A representative object A representing the objects A-1 through A-5 is placed in the vicinity of the objects A-1 through A-5. The term “vicinity” means a closeness in the xR space that allows the user to visibly recognize that the representative object A is somehow related to the objects A-1 through A-5. Referring to FIG. 5, the objects A-1 through A-5 are oriented to the representative object A. In other words, the representative object A is centered at a space surrounded by the objects A-1 through A-5. This arrangement is an example of an association between the representative object and the objects belonging to the representative object.

The document 46 is displayed as pages B-1 through B-5 serving as objects in the xR space defined by three axes X, Y, and Z. The pages are hereinafter referred to as objects B-1 through B-5. A representative object B representing the objects B-1 through B-5 is placed in the vicinity of the objects B-1 through B-5. The term “vicinity” also means a closeness in the xR space that allows the user to visibly recognize that the representative object B is somehow related to the objects B-1 through B-5.

Referring to FIG. 5, the representative objects A and B are displayed as cubes. The representative objects A and B may be different from their objects in terms of one of the shape, pattern, color, character of each of the objects such that the user may easily identify the representative object. For example, the representative objects A and B may be colored blue or may have the shape of a clip. The user may easily understand from the shape that the representative objects A and B have the function of grouping their objects. Document names may be displayed in the vicinity of the representative objects A and B. For example, a name “Document A” is displayed in the vicinity of the representative object A.

The representative objects A and B may be a single object or a combination of objects. For example, an object may be a cube surrounded by balls.

The operation of the representative objects A and B may be triggered when the object serving as the inputter 12, such as the object 36 as the virtual hand in FIG. 3, touches the representative objects A and B. Alternatively, the operation of the representative objects A and B may be triggered by a specific operation signal from the inputter 12 with the object 36 touching or overlapping the representative objects A and B.

The contents of the operation on the representative objects A and B may be predetermined or selected in response to the operation signal from the inputter 12. The contents of the operation on the representative objects A and B may be selected in accordance with a position where the object 36 touches the representative objects A and B. Furthermore, the movement of the representative objects A and B may be calculated through physical simulation and the contents of the operation on the representative objects A and B may be selected based on the calculation results.

The representative objects may be arranged in a hierarchical structure. For example, the representative object B may belong to the representative object A and the representative object A functions as a higher representative object and the representative object B functions as a lower representative object.

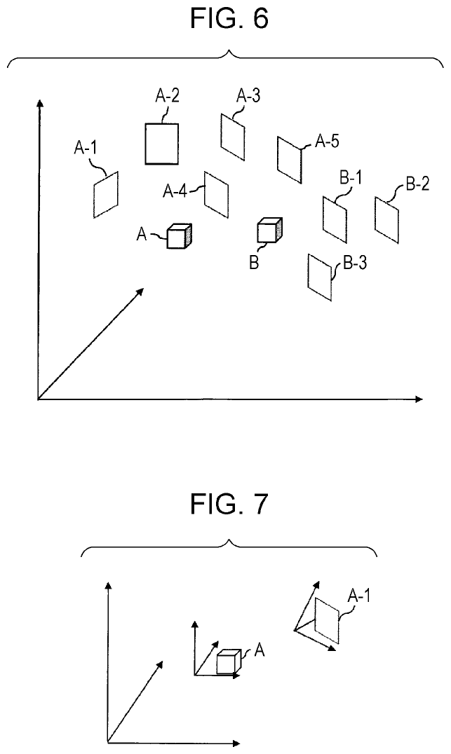

FIG. 6 illustrates the hierarchical structure of the representative objects. The objects A-1 through A-5 and the representative object B belong to the representative object A. The objects B-1 through B-3 belong to the representative object B.

The operation performed on the representative object A is also performed on the representative object B and the objects A-1 through A-5 belonging to the representative object A. As a result, the operation performed on the objects B-1 through B-3 belonging to the representative object B is performed in the same way as on the representative object B.

On the other hand, the operation performed on the representative object B is also performed on the objects B-1 through B-3. This operation does not affect the objects A-1 through A-5.

The data structure of the representative object is specifically described.

FIG. 7 illustrates a coordinate system of a representative object A and an object A-1 belonging to the representative object A.

The xR space is a 3D coordinate system defined by three axes, namely, X, Y, and Z axes. All the objects including the representative object have their own coordinate systems and each coordinate system has data on a position and posture in the xR space coordinate system (absolute coordinates). The position data is stored as a 3D vector, such as (x,y,z). The posture data is stored as Euler angles, such as (α, β, γ).

If an object has a shape, the object has shape information on the shape.

The object has attribute information. For example, the attribute information may include information on the representative object, name representing the object, and order of objects belonging to the same representative object.

The object belonging to the representative object has data on a position and posture of a coordinate system of that object with respect to the coordinate system of the representative object (relative coordinates). The data may be calculated in advance or may be calculated each time the information presentation system is used.

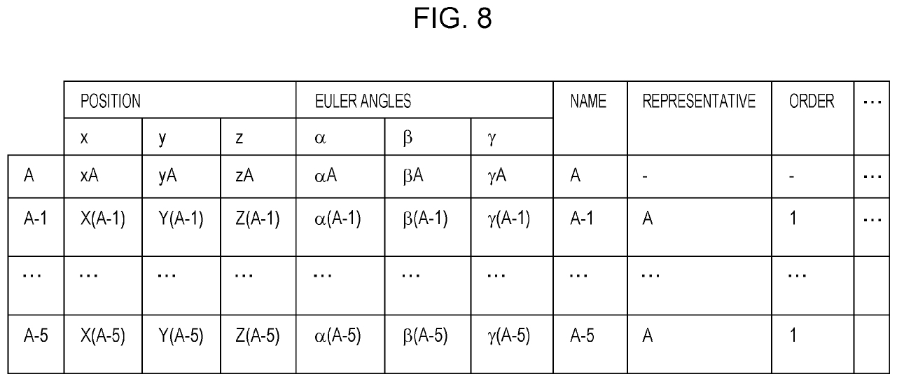

FIG. 8 specifically illustrates the data structure of the representative object A and the objects A-1 through A-5. The representative object A has position data on the coordinate system of the xR space, Euler angles as the posture data, name as the attribute information, name of the representative object which the representative object A belongs to, and order of the representative object A. Since the representative object A is a representative object itself and does not belong to any other object, the name of the representative object which the representative object A belongs to is not present (null data).

### Process Flowchart

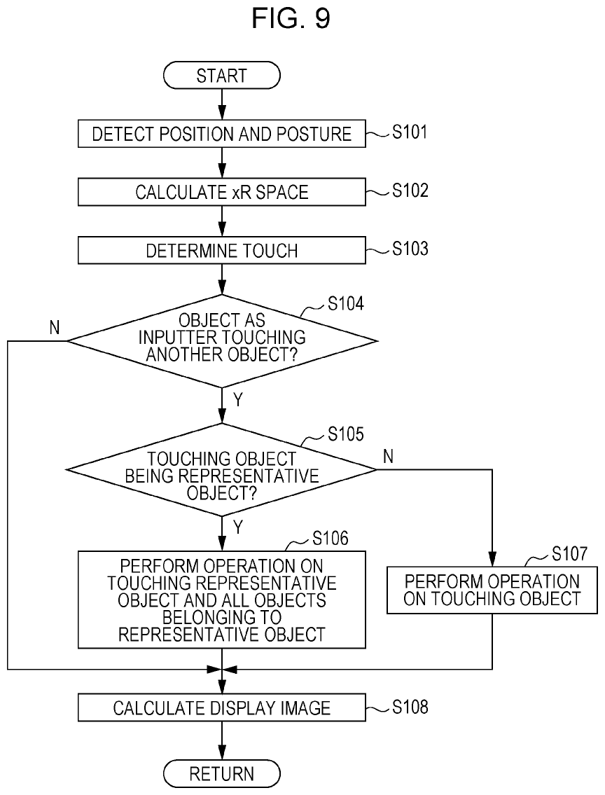

FIG. 9 is a flowchart of the exemplary embodiment. The process in FIG. 9 is triggered when the object 36 as the inputter 12 touches a document as an object.

The position and posture detector 14 detects the positions and postures of the display 10 and the inputter 12 (step S101). The position and posture detector 14 outputs the detected position data and posture data to the xR space calculating unit 16.

The xR space calculating unit 16 calculates the xR space (S102) and outputs the calculated xR space to the display image calculating unit 20. The display image calculating unit 20 calculates a display image to be displayed on the display 10 and outputs the display image to the display 10. FIG. 3 illustrates an example of the display image that includes the objects 40 and 42 as the document and the object 36 as the virtual hand serving as the inputter 12 as the object. If a given document includes multiple pages, the display image includes each page as an object and the representative object representing the pages.

The touch determination unit 18 determines whether the object 36 of the inputter 12 touches the document as an object in the display image (S103 and S104).

If the object 36 touches the object (yes path is followed in S104), the touch determination unit 18 determines whether the object touched by the object 36 of the inputter 12 is a representative object (S105).

If the representative object is touched (yes path is followed in S105), the arithmetic unit 22 calculates the positions and postures of the touching representative object and all the objects belonging to the representative object in order to perform an operation specified by the user on the representative object and the objects, and outputs the calculation results to the display image calculating unit 20 (S106). The display image calculating unit 20 calculates and creates a display image after the operation in accordance with the calculation results and outputs the display image to the display 10 (S108). The operation specified by the user includes moving the objects, displaying or undisplaying the objects, aligning the objects, indicating an object belonging to the representative object, partially selecting the objects, and changing the representative object. Specific contents of the operation are further described in detail below.

If the representative object is not touched (no path is followed in S105), the arithmetic unit 22 calculates the position and posture of the touched object in order to perform the operation specified by the user on the touched object and outputs the calculation results to the display image calculating unit 20 (S107). The display image calculating unit 20 calculates a display image after the operation performed in accordance with the calculation results from the arithmetic unit 22 and outputs the display image to the display 10 (S108). The operations in S101 through S108 are repeated with a specific control period.

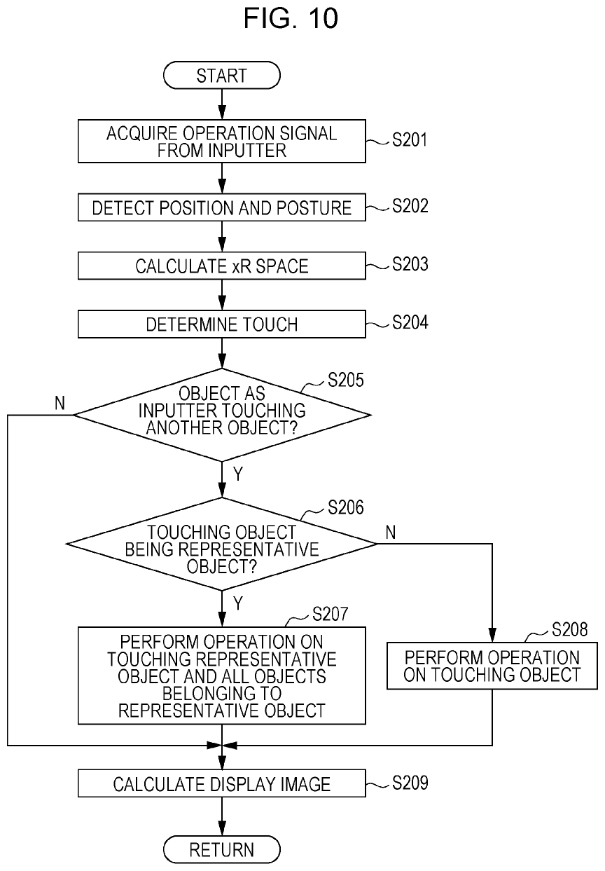

FIG. 10 is another process flowchart of the exemplary embodiment. The process in FIG. 10 is triggered by an operation signal from the inputter 12.

The operation signal from the inputter 12 is acquired (S201). When the operation signal is received from the inputter 12, the same operations as the operations in S101 through S108 in FIG. 9 are performed. The objects are operated in response to user operation and the operation results are output to the display 10 (S202 through S209).

The specific process using the representative object is described below.

### Movement

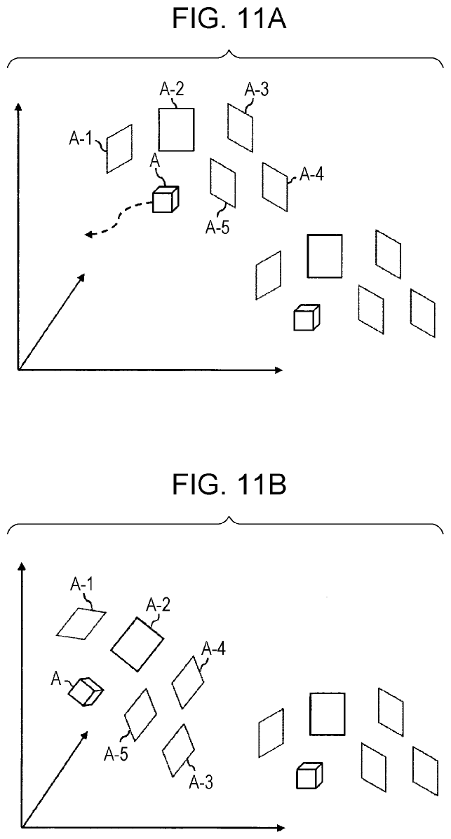

FIGS. 11A and 11B illustrate display examples in the xR space when an operation to move the representative object is performed. FIG. 11A illustrates the display example prior to the movement and FIG. 11B illustrates the display example subsequent to the movement.

When the user has moved the representative object A, the objects A-1 through A-5 belonging to the representative object A move with the relative positions and posture thereof maintained. For example, in the case of the xR controller with the inputter 12 having a button, when the user presses the button with the inputter 12 as the object, specifically, the object 36 in FIG. 3 touching or overlapping the representative object A in the xR space, the representative object A and the objects A-1 through A-5 belonging to the representative object A start to move. The movement continues while the button is pressed. The movement is performed in alignment with the position and posture of the inputter 12. When the button is released, the movement stops. The representative object A and the objects A-1 through A-5 belonging thereto are placed at the position and posture at the time of the movement stop in the xR space.

If the hand 32 is sensed and used as the inputter 12, a gesture of the user may be used in place of the pressing operation of the button.

### Movement of Representative Object

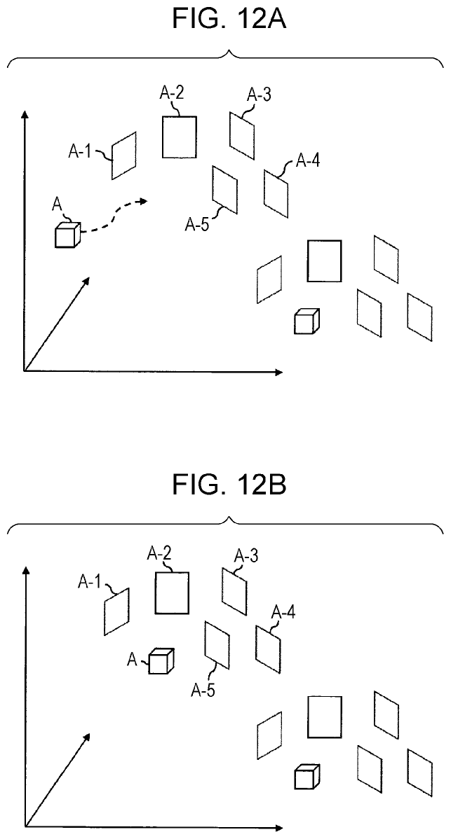

FIGS. 12A and 12B illustrates display examples of the xR space when only the representative object is moved. FIG. 12A illustrates the display example prior to the movement and FIG. 12B illustrates the display example subsequent to the movement.

This mode is used to move only the representative object A in order to re-adjust the position and posture of the representative object A in alignment with the positions of the objects A-1 through A-5 belonging to the representative object A. This mode may be used when page arrangement is not balanced. In this mode, the positions and postures of the objects A-1 through A-5 belonging to the representative object A are maintained while the position and posture of only the representative object A are modified. Only the position of the representative object A or only the posture of the representative object A may be modified. Mode switching may be performed by the user pressing the button or the gesture of the user.

Specifically, in the case of the xR controller with the inputter 12 having the button, when the user presses the button with the inputter 12 as the object, specifically, the object 36 in FIG. 3 touching or overlapping the representative object A in the xR space, the representative object A starts to move. The movement continues while the button is pressed. The movement is performed in alignment with the position and posture of the inputter 12. When the button is released, the movement stops. The representative object A is placed at the position and posture at the time of the movement stop in the xR space.

Switching between Displaying and Undisplaying

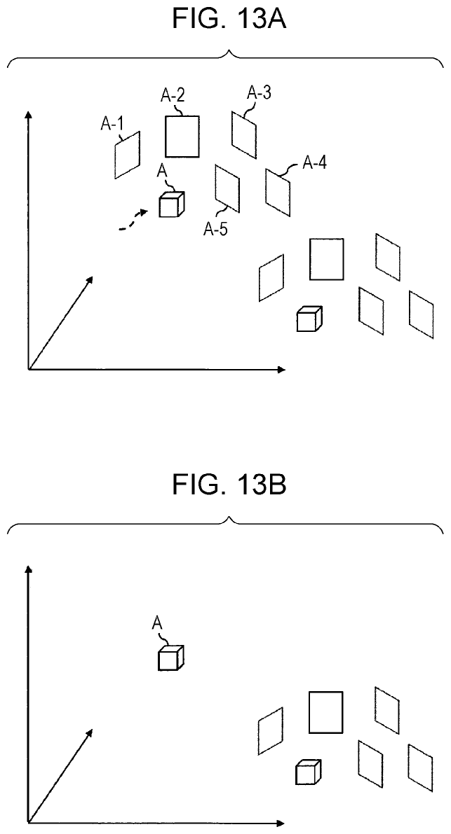

FIGS. 13A and 13B illustrate display examples of the xR space when a display operation or undisplay operation is performed on the representative object. FIG. 13A illustrates the display example of a display state and FIG. 13B illustrates the display example in a undisplay state.

When a display/undisplay switch operation is performed on the representative object A, the switch operation between displaying and undisplaying is performed on the objects A-1 through A-5.

Whether the representative object A is in a display state or undisplay state may be displayed to the user by a change in shape or color.

Specifically, in the case of the xR controller with the inputter 12 having the button, the user may switch the objects A-1 through A-5 belonging to the representative object A between the display state and undisplay state by pressing the button with the inputter 12 as the object, specifically, the object 36 in FIG. 3, touching or overlapping the representative object A in the xR space.

After activating the mode to switch the display/undisplay using a button operation, the user may switch between the display state and the undisplay state by causing the inputter 12 as the object to touch the representative object A in the xR space.

### Alignment

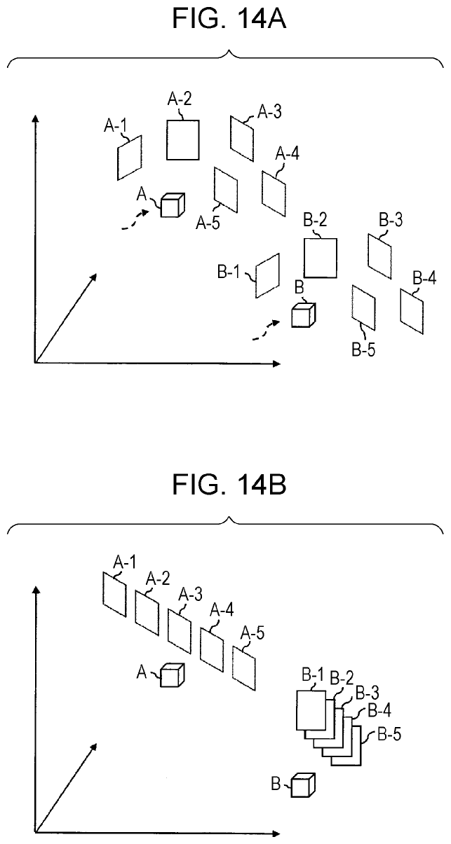

FIGS. 14A and 14B illustrate display examples of the xR space when an alignment operation is performed on the representative object. FIG. 14A illustrates the display example prior to the alignment and 14B illustrates the display example subsequent to the alignment.

When the alignment operation is performed on the representative objects A and B, objects A-1 through A-5 belonging to the representative object A and objects B-1 through B-5 belonging to the representative object B are aligned in accordance with attributes of the objects.

In the case of the xR controller with the inputter 12 having the button, when the user presses the button with the inputter 12 as the object, specifically, the object 36 in FIG. 3, touching or overlapping the representative object A in the xR space, the objects A-1 through A-5 belonging to the representative object A are moved with an alignment state thereof maintained. Similarly, when the user presses the button with the object 36 in FIG. 3 touching or overlapping the representative object B, the objects B-1 through B-5 belonging to the representative object B are moved with the alignment state thereof maintained.

After activating the alignment switch mode using the button, the user may align the objects by causing the object 36 of the inputter 12 to touch the representative object A in the xR space. Alternatively, an icon object used to instruct the objects to align with the vicinity of the representative object A may be placed and the objects may be aligned by causing the object 36 of the inputter 12 to touch the icon object. Depending on the type of alignment, the type of the button to be switched may be changed. By changing the number of pressings of the button, the user may change the type of alignment. FIG. 14B indicates that the type of alignment is different from the representative object A to the representative object B.

### Differentiating Blocks

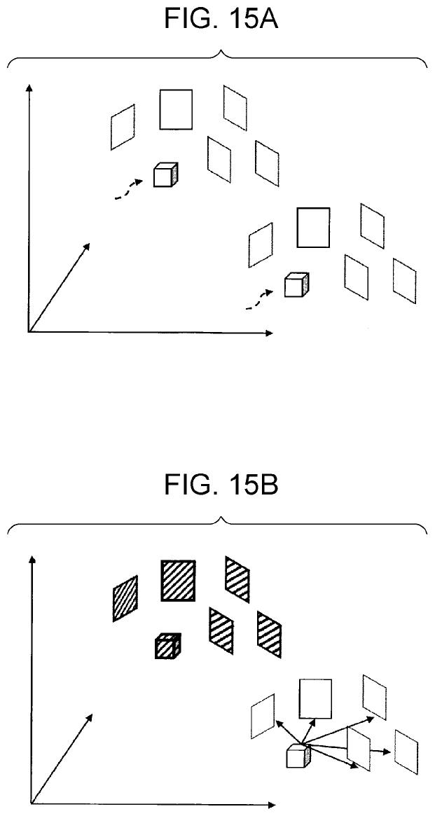

FIGS. 15A and 15B illustrate display examples of the xR space when a differentiating operation is performed on the representative object. FIG. 15A illustrates the display example prior to the differentiating operation and 15B illustrates the display example subsequent to the differentiating operation.

When the differentiating operation is performed on the representative objects A and B, the objects belonging to each of the representative objects A and B are differentiated.

In the case of the xR controller with the inputter 12 having a button, when the user presses the button with the inputter 12 as the object, specifically, the object 36 in FIG. 3, touching or overlapping the representative object A in the xR space, an object belonging to the representative object A is clearly indicated. The object may be displayed in any display form. For example, the outlines of the objects belonging to the same representative object may be switched to the same color or the objects belonging to the same representative object may be indicated by an arrow. Referring to FIG. 15B, the objects belonging to the same representative object may be displayed in the same color (in the hatched areas in FIG. 15B), and the objects belonging to the representative object B are indicated by respective arrows with an arrow-head end at each object and a start end at the representative object B. In summary, the objects belonging to the same representative object serving as an operation target are relatively emphasized in comparison with the rest of the objects.

### Partial Selection

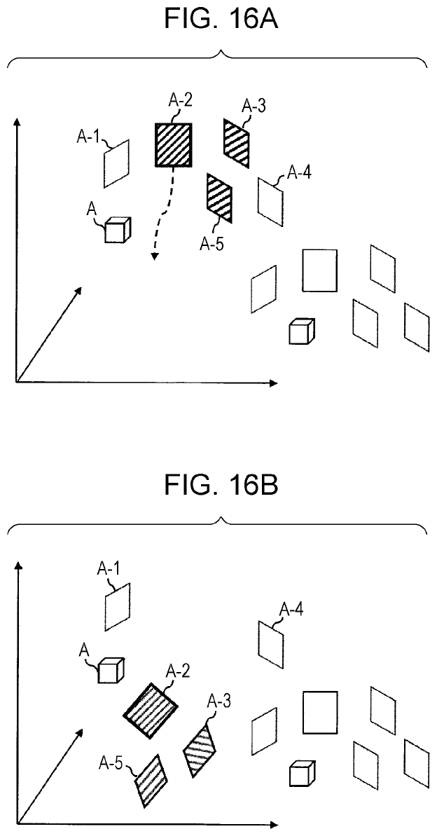

FIGS. 16A and 16B illustrate display examples of the xR space when a partial selection operation is performed on the representative object. FIG. 16A illustrates the display example prior to the partial selection operation and 16B illustrates the display example subsequent to the partial selection operation.

The information presentation system of the exemplary embodiment collectively operates at a time all the objects belonging to the representative object by operating the representative object. Alternatively, a partial selection mode may be implemented to operate only a specific object among the objects belonging to the representative object. The partial selection mode further includes a selection submode and an operation submode. The information presentation system may be switched between the selection submode and the operation submode in response to a button in use or an button operation.

In the selection submode, the user may select an object by causing the object 36 of the inputter 12 to touch an object to be selected. Specifically, if the object 36 touches objects A-2, A-3, and A-5, these three objects are selected. The outlines of the selected objects are changed in color such that the user may identify the selected objects.

In the partial selection, any of the selected objects has the same function as that of the representative object. For example, if the movement operation is performed on the object A-2, the same movement operation is performed on the objects A-3 and A-5 with the object A-2 functioning as the representative object.

### Changing Representative Object

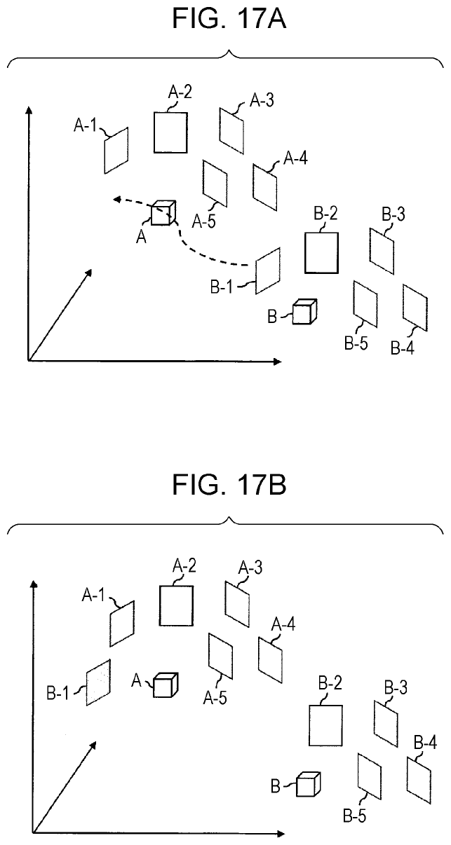

FIGS. 17A and 17B illustrate display examples of the xR space when a changing operation is performed on the representative object. FIG. 17A illustrates the display example prior to the changing operation and 17B illustrates the display example subsequent to the changing operation.

An object belonging to a representative object may be set to belong to another representative object.

For example, in order to change one representative object to another, an object may be moved to cause the object to touch another representative object that is different from the original representative object of the object. By moving the object B-1 belonging to the representative object B to cause the object B-1 to touch the representative object A, the user causes the object B-1 to change from the representative object B to the representative object A.

According to the exemplary embodiment, objects as multiple pages forming a document in the xR space may be displayed, and a representative object representing the objects is displayed and the objects belonging to the representative object may thus be collectively operated at a time by operating the representative object. Time to operate each object may thus be saved.

### Modifications

If a document includes multiple pages, objects of the pages and a representative object representing the objects are displayed in the xR space. Even when the document includes only one page, the representative object may be created and displayed in the close vicinity of the object. Referring to FIGS. 17A and 17B, an object belonging to a representative object may be set to belong to another representative object.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information presentation system comprising:
a display that provides a virtual three-dimensional (3D) work space to a user;
an inputter that the user uses to operate an object in the virtual 3D work space; and
a processor configured to
cause the display to display the 3D work space,
cause the display to display a document in the 3D work pace,
cause the display to display in the 3D work space a representative object representing the document, in association with the document, and
in response to detection of an operation performed on the representative object by the inputter in the 3D work space, perform a process to process a plurality of pages forming the document represented by the representative object.

2. The information presentation system according to claim 1, wherein the processor is configured to, in response to detection of a movement operation on the representative object performed by the inputter, perform a process to move the representative object while maintaining a relative positional relationship of the plurality of pages forming the document represented by the representative object.

3. The information presentation system according to claim 1, wherein the processor is configured to, in response to detection of a switch operation performed by the inputter to switch between displaying and undisplaying the representative object, perform a process to switch between collectively displaying and collectively undisplaying the plurality of pages forming the document represented by the representative object.

4. The information presentation system according to claim 1, wherein the processor is configured to, in response to detection of a specific operation performed on the representative object by the inputter, perform a process to collectively align the plurality of pages forming the document represented by the representative object.

5. The information presentation system according to claim 1, wherein the representative object has a hierarchical structure that includes, at least, a higher representative object and a lower representative object that is hierarchically lower than the higher representative object.

6. The information presentation system according to claim 2, wherein the representative object has a hierarchical structure that includes, at least, a higher representative object and a lower representative object that is hierarchically lower than the higher representative object.

7. The information presentation system according to claim 3, wherein the representative object has a hierarchical structure that includes, at least, a higher representative object and a lower representative object that is hierarchically lower than the higher representative object.

8. The information presentation system according to claim 4, wherein the representative object has a hierarchical structure that includes, at least, a higher representative object and a lower representative object that is hierarchically lower than the higher representative object.

9. The information presentation system according to claim 1, wherein the representative object includes a partial representative object that temporarily represents a part of the plurality of pages forming the document.

10. The information presentation system according to claim 2, wherein the representative object includes a partial representative object that temporarily represents a part of the plurality of pages forming the document.

11. The information presentation system according to claim 3, wherein the representative object includes a partial representative object that temporarily represents a part of the plurality of pages forming the document.

12. The information presentation system according to claim 4, wherein the representative object includes a partial representative object that temporarily represents a part of the plurality of pages forming the document.

13. The information presentation system according to claim 1, wherein the processor is configured to, in response to detection of a specific operation performed on the representative object by the inputter, perform a process to move only the representative object without moving the plurality of pages forming the document represented by the representative object.

14. The information presentation system according to claim 1, wherein the processor is configured to, in response to detection of an operation performed on the representative object by the inputter, perform a process to change a display form of the plurality of pages forming the document represented by the representative object corresponding to the detected operation.

15. The information presentation system according to claim 14, wherein the processor is configured to perform a process to display the plurality of pages forming the document represented by the representative object corresponding to the detected operation, in a manner such that a relationship of the plurality of pages with the representative object is identifiable.

16. The information presentation system according to claim 1, wherein the processor is configured to
perform a process to display, as the representative object, a first representative object representing a first document and a second representative object representing a second document, and
in response to detection of an operation performed by the inputter to associate a specific page forming the first document with the second representative object, perform a process to transfer a representing destination of the specific page from the first representative object to the second representative object.

17. A non-transitory computer readable medium storing a program causing a computer to execute a process for presenting information, the process comprising:
displaying a three-dimensional (3D) work space on a display;
displaying a document in the 3D work pace;
displaying in the 3D work space a representative object, representing the document, in association with the document; and
in response to detection of an operation on the representative object performed by an inputter in the 3D work space, performing a process to process a plurality of pages forming the document represented by the representative object.

18. An information presentation system comprising:
means for displaying on a display a virtual three-dimensional (3D) work space to a user;
means for operating an object in the virtual 3D work space; and
means for causing the display to display the 3D work space,
causing the display to display a document in the 3D work pace,
causing the display to display in the 3D work space a representative object representing the document, in association with the document, and
in response to detection of an operation performed on the representative object by the inputter in the 3D work space, performing a process to process a plurality of pages forming the document represented by the representative object.
